(19) United States
(12) Patent Application Publication
(10) Pub. No.: US 2015/0355676 A1
(43) Pub. Date: Dec. 10, 2015

(54) ELECTRONIC DISPLAYS INTERCHANGEABLE WITH DIFFERENT ENTITIES

(71) Applicant: HEWLETT PACKARD DEVELOPMENT COMPANY, L.P., Houston, TX (US)

(72) Inventor: Tony Anuez, Houston, TX (US)

(21) Appl. No.: 14/377,569

(22) PCT Filed: Jun. 25, 2012
(86) PCT No.: PCT/US2012/043957

§ 371 Date: Aug. 8, 2014

(51) Int. Cl. G06F 1/16; G02F 1/1333; G06F 3/14; G06F 3/147

(52) U.S. Cl. CPC G06F 1/1601; G06F 3/147; G02F 1/13338; G06F 3/1423

(57) ABSTRACT

A system includes a plurality of electronic displays, each defined by respective characteristics. Each display can be interchangeably used, one at a time, with any of a plurality of different electronic entities. A display and an electronic entity define a particular integrated device when operably mated together. Monitors, all-in-one computers, point-of-sale equipment and other apparatus and devices can be defined and used in accordance with the interchangeable displays of the present teachings.

### BACKGROUND

Various types of devices such as computers, television monitors and so on include respective electronic displays. Graphical depictions, alpha-numeric characters, photo or video images and the like are viewable by a user on such an electronic display.

Connecting cables, power supplies, adjustable stands or support structures, and other features are typical of such devices that include dedicated purpose electronic displays. Increased versatility and reduced cost-of-production among electronic displays are sought after by manufacturers, suppliers and users. The present teachings address the foregoing and related concerns.

### BRIEF DESCRIPTION OF THE DRAWINGS

The present embodiments will now be described, by way of example, with reference to the accompanying drawings, in which:

FIG. 1 depicts a side elevation of a computer monitor using an interchangeable display according to one example of the present teachings;

FIG. 2 depicts a side elevation of an all-in-one computer using the interchangeable display of FIG. 1;

FIG. 3 depicts a block diagram of a system of plural displays and plural electronic entities according to yet another example; and

FIG. 4 depicts a flow diagram of method in accordance with another example of the present teachings.

### DETAILED DESCRIPTION

### Introduction

A system includes a plurality of electronic displays, each defined by respective characteristics. Each display within a system can be interchangeably used with any of a plurality of different electronic entities. Such a display and an electronic entity define a particular integrated device when they are operably mated together. Monitors, all-in-one computers, point-of-sale equipment and other apparatus and devices can be defined and used accordingly. Varying systems having respective numbers of displays and electronic entities with which they operate can be defined and used.

In one example, an apparatus includes an electronic display configured to be interchangeably mated to a plurality of different other entities. The electronic display includes a housing configured to be positionably supported by a corresponding feature of each of the other entities. Additionally, the electronic display is configured to receive operating power and electronic signaling from each of the other entities.

In another example, a system includes a plurality of electronic displays defined by respectively different sizes. Each of the electronic displays is configured to receive operating power and electronic signals from another entity. The system also includes a plurality of different electronic entities, each of which is configured to be operably mated to and positionably supportive of any one of the electronic displays. Respective integrated devices are thus definable.

In yet another example, a method includes electrically coupling an electronic display to one of a plurality of different electronic entities. The method also includes providing electrical operating power and electronic signals to the electronic display from electronic entity that is coupled thereto. The method further includes positionably supporting the electronic display by way of a corresponding feature of the coupled electronic entity. The electronic display and the coupled electronic entity collectively define an integrated device.

### First Illustrative Device

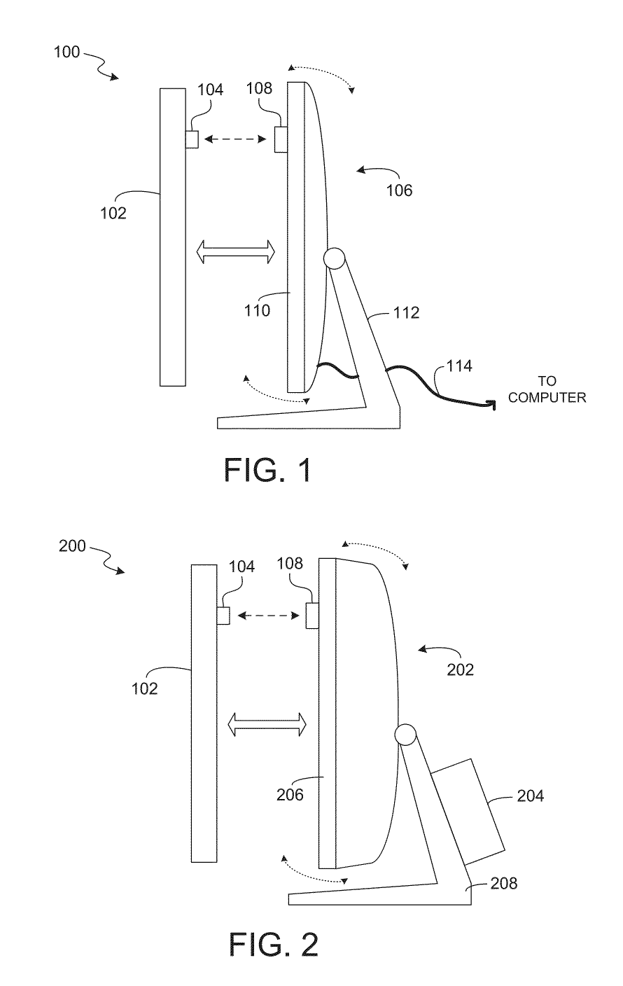

Attention is now turned to FIG. 1, which depicts a side elevation of a device 100 according to the present teachings. The device 100 is illustrative and non-limiting with respect to the present teachings. Other devices, apparatus, systems and elements having other respective characteristics can also be defined and used. The device 100 is also referred to as a computer monitor 100 for purposes herein.

The device 100 includes an electronic display 102. The electronic display 102 is configured to display graphics, text and other images on user-viewable screen, such as a liquid-crystal display (LCD), a light-emitting diode (LED) display, or other suitable construct. In one example, the display 102 is a touch-sensitive LCD-type display. Other suitable types can also be used. The display 102 includes a scalar board or electronic circuitry configured to process electronic signals into a displayable format.

The electronic display 102 includes an electronic signal connector (connector) 104. The connector 104 is configured to electrically couple the electronic display 102 to any one of a plurality of different other entities as described below. Thus, the connector 104 is referred to as a first type of connector 104 for purposes of the present teachings. While a single connector 104 is depicted in the interest of clarity, it is to be understood that the display 102 can include any suitable number of connectors, being of the same or varying form-factors and configurations.

The device 100 also includes a monitor unit 106. The monitor unit 106 is also referred to as an electronic entity 106 for purposes herein. The monitor unit 106 includes a power supply, input/output circuitry, and other resources as required to be coupled to a computer or other apparatus. The monitor unit 106 also includes an electronic signal connector (connector) 108.

The connector 108 is configured to electrically couple to the connector 104 so as to provide operating electrical power, electronic signals, data or the like from the monitor unit 106 to the electronic display 102. The monitor unit 106 can include any suitable number or configuration of such connectors, and the single illustrative connector 108 is depicted in the interest of clarity.

The monitor unit 106 includes a housing 110 and a base or standard 112 configured to support the housing 110 upon a desktop, counter or other surface. The housing 110 is configured to receive at least a portion of the electronic display 102 when operably mated thereto. Thus, the electronic display 102 and the monitor unit 106 collectively define the computer monitor 100 when electrically and mechanically engaged to each other.

The housing 110 is angularly positionable (i.e., tiltable) with respect to the base 112 such that a user can adjust a viewing angle of the electronic display 102 during typical normal use. The monitor unit 106 also includes a cable 114 configured to couple the computer monitor 100 to a desktop computer, a laptop output port, a file server or other processor-based apparatus.

The electronic display 102 and the monitor unit 106 can be electrically and mechanically coupled to each other such that an integrated device—the computer monitor 100—is defined. Conversely, the electronic display 102 can be removed from the monitor unit 106 and coupled to a different device so as to define a different integrated device.

The monitor unit 106 is an illustrative and non-limiting example of a plurality of different electronic entities that the electronic display 102 can be interchangeably coupled (i.e., mated, or joined) to. In turn, the electronic display 102 is an illustrative and non-limiting example of a plurality of different displays that can be interchangeably mated with a plurality of different entities, another example of which is described below. Thus, the present teachings contemplate diverse systems of one or more electronic displays each compatible with one or more different electronic entities so as to define respective integrated devices.

### Second Illustrative Device

Attention is directed now to FIG. 2, which depicts a side elevation of a device 200 according to the present teachings. The device 200 is illustrative and non-limiting with respect to the present teachings. Other devices, apparatus, systems and elements having other respective characteristics can also be defined and used. The device 200 is also referred to as an all-in-one (AIO) computer 200 for purposes herein.

The device 200 includes the electronic display 102, having the illustrative electronic signal connector 104, as respectively described above. The device 200 also includes an AIO computer unit (computer) 202. The computer 202 includes a housing portion 204 configured to support a power supply, a motherboard with one or more processors (CPUs), memory, a hard-disk drive, a compact disk (CD) drive, input/output circuitry, network or wireless communications resources, and other suitable resources not germane to the present teachings.

The computer 202 also includes the illustrative electronic signal connector 108 as described above. The computer 202 is therefore configured to electrically couple to the connector 104 so as to provide operating electrical power, electronic signals, data or the like to the electronic display 102. The computer 202 can include any suitable number or configuration of such connectors, and the single connector 108 is depicted in the interest of clarity.

The computer 202 further includes a housing portion 206 and a base portion 208 configured to support the housing portion 206 upon a desktop, counter, and so on. The housing portion 206 is configured to receive at least a portion of the electronic display 102 when operably mated thereto. Thus, the electronic display 102 and the computer 202 collectively define the all-in-one computer 200 when electrically and mechanically engaged to each other. The housing portion 206 is angularly positionable with respect to the base 208 allowing user adjustment of a viewing angle of the electronic display 102.

### Illustrative System

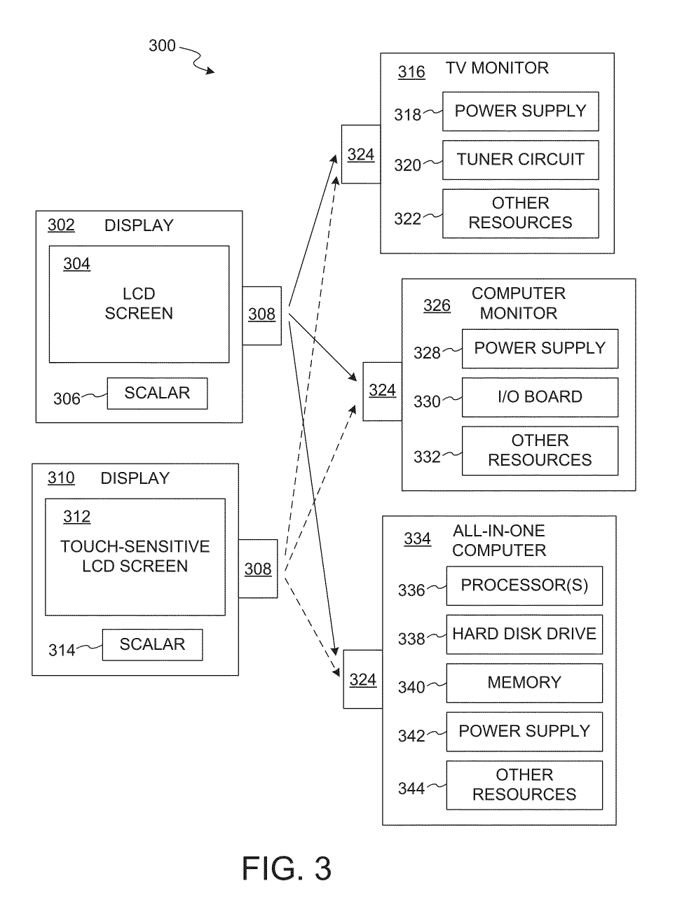

Reference is now made to FIG. 3, which depicts a system 300 in accordance with the present teachings. The system 300 is illustrative and non-limiting, and other systems, configurations and respective entities are also contemplated.

The system 300 includes an electronic display (display) 302. The display 302 includes an LCD screen 304, a scalar board (circuitry) 306, and an illustrative electronic signal connector (connector) 308. The display 302 is configured to receive operating electrical power and electronic signals from another entity (examples described below) by way of the connector 308. The display is further configured to process such electronic signals by way of the scalar board 306 and to display corresponding images, text, graphics and the like on the LCD screen 304.

The system 300 also includes an electronic display (display) 310. The display 310 includes a touch-sensitive LCD screen 312, a scalar board (circuitry) 314, and an illustrative connector 308. The display 310 is configured to receive operating electrical power and electronic signals from another entity by way of the illustrative connector 308 or other suitable connectors (not shown). The display is further configured to process such electronic signals by way of the scalar board 314 and to display corresponding images, text, graphics and the like on the touch-sensitive LCD screen 312.

The system 300 further includes a television (TV) monitor 316. The TV monitor 316 includes a power supply 318, a tuner circuit 320 for receiving and processing digitally encoded television signaling, and other resources 322. One having ordinary skill in the electronic arts is familiar with various other resources 322 that can be included with a television monitor in general, and further elaboration is not germane to the present teachings.

The TV monitor 316 also includes an electronic signal connector (connector) 324 that is connectable (i.e., compatible) with the respective connectors 308 of the display 302 and the display 310. Thus, the TV monitor 316 is configured to be operably mated, one at a time, to either of the displays 302 or 310. The TV monitor 316 and the correspondingly mated display 302 or 310 then define an integrated device configured for viewing television-format content.

The system 300 also includes a computer monitor 326. The computer monitor 326 includes a power supply 328, an input/output (I/O) board (circuitry) 330 for bidirectional communication of digital signals, and other resources 332. One having ordinary skill can appreciate various such other resources 332, and further elaboration is not germane to the present teachings.

The computer monitor 326 also includes a connector 324 compatible with the respective connectors 308 of the display 302 and the display 310. The computer monitor 326 and the correspondingly mated display 302 or 310 then define an integrated device configured for viewing graphics, alphanumeric text, photos, videos or other information provided by a general-purpose computer (e.g., desktop, laptop, and so on).

The system 300 additionally includes an all-in-one computer 334. The AIO computer 334 includes one or more processors 336, a hard-disk drive 338, processor-accessible storage memory 340, a power supply 342, and other resources 344. One having ordinary skill in the computer arts can appreciate various such other resources 344, and further elaboration is not germane to the present teachings.

The AIO computer 334 also includes a connector 324 compatible with the respective connectors 308 of the display 302 and the display 310. The AIO computer 334 and the correspondingly mated display 302 or 310 then define an integrated device configured for viewing graphics, alphanumeric text, photos or videos, and for performing any suitable range of functions germane to a general-purpose computer.

The system 300 includes two respective displays 302 and 310, each of which is interchangeable and operable with any of the respective entities 316, 326 and 334. For non-limiting example, the display 302 can be joined to the computer monitor 326, while the display 310 can be joined to the AIO computer 334, such that independent and contemporaneous operation of the respective integrated devices can be performed. Other combinations can also be used. Furthermore, each of the displays 302 and 310 is configured to be removably mechanically engaged and supported by any one of the entities 316, 326 and 334.

### Illustrative Method

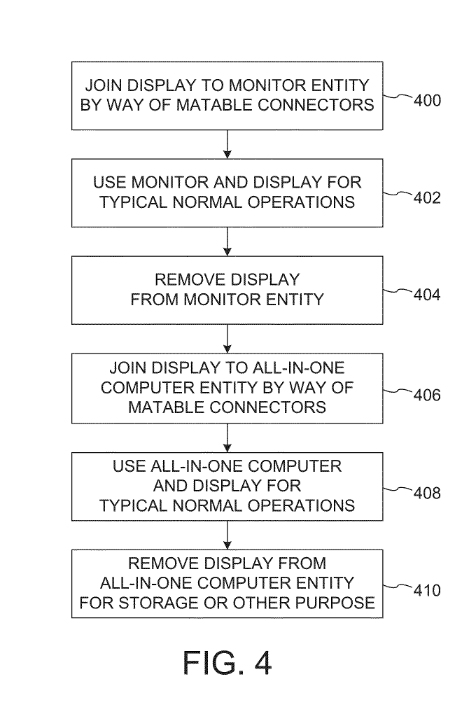

Reference is now made to FIG. 4, which depicts a flow diagram of a method according to the present teachings. The flow diagram depicts particular steps performed in a specific order of execution. However, other methods including other steps, omitting one or more of the depicted steps, or proceeding in other orders of execution can also be used. Thus, the method of FIG. 4 is illustrative and non-limiting with respect to the present teachings. Reference is also made to FIG. 3 in the interest of illustrating the method of FIG. 4.

At 400, a display is joined to a monitor entity by way of matable connectors. For purposes of illustration, a display 302 is joined to a computer monitor (entity) 326 by way of respective connectors 308 and 324. The display 302 is mechanically supported by the computer monitor 326 and is coupled to receive operating electrical power and electronic signals there from. An integrated device—namely, a complete computer monitor—is now defined.

At 402, the monitor and display are used for typical normal operations. For purpose of the present illustration, the computer monitor 326 receives digital information from a desktop computer coupled thereto. In turn, electronic signals and operating power are provided from the computer monitor 326 to the display 302. The display 302 presents images, text, graphics, and so on by way of an LCD screen 304 to a user.

At 404, the display is removed from the monitor entity. In the present example, the display 302 is detached (i.e., decoupled) from the computer monitor 326 by way of separating the connectors 308 and 324. Separate and distinct display 302 and computer monitor 326 entities are once again defined.

At 406, the display is joined to an all-in-one computer entity by way of the matable connectors. In the present example, the display 302 is joined to an AIO computer 334 by way of respective connectors 308 and 324. The display 302 is mechanically supported by the AIO computer entity 334 and is coupled to receive operating electrical power and electronic signals there from. An integrated device—a complete all-in-one computer—is now defined.

At 408, the AIO computer and display are used for typical normal operations. For purpose of the present illustration, the AIO computer 334 includes at least one processor 336 operating in accordance with a machine-readable program code. Electronic signals are provided from the AIO computer 334 to the display 302, and the display 302 displays images, text, graphics, and so on to a user in accordance with such signaling.

At 410, the display is removed from the AIO computer entity for storage or another purpose. For purposes of the present example, the display 302 is removed (decoupled or disengaged) from AIO computer entity 334 such that separate and distinct entities are again defined. The display 302 is then placed in storage, while a different display (e.g., display 310) is selected for use.

The present teachings contemplate any number of systems and operating scenarios in which a plurality of different displays, having respectively varying form factors or other characteristics, are interchangeably useable with a plurality of different electronic entities. Each display can be mated to one other entity at a time by way of compatible connectors and without the need for appreciable cabling. Additionally, each display receives operating power from the entity to which it is presently mated, thus reducing display materials and cost of production.

Distinct systems including computers, television or video monitors, all-in-one apparatus, printing devices, point-of-sale or cash handling equipment, or other entities can be defined that make interchangeable use of one or more distinct displays. The present teachings also contemplate reduced costs for consumers (end users) to maintain a plurality of displays on hand in the interest of decreased “down time” and increased productivity and versatility.

In general, the foregoing description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

What is claimed is:

1. An apparatus, comprising:
an electronic display configured to be interchangeably mated to a plurality of different other entities, the electronic display including a housing configured to be positionably supported by a corresponding feature of each of the other entities, the electronic display configured to receive operating power and electronic signaling from each of the other entities.

2. The apparatus according to claim 1, the electronic display and at least one of the other entities collectively defining either a video monitor or a computer monitor.

3. The apparatus according to claim 1, the electronic display and at least one of the other entities collectively defining an all-in-one (AIO) computer.

4. The apparatus according to claim 1, the housing of the electronic display further configured to be at least partially received within a housing of at least one of the other entities.

5. The apparatus according to claim 1, the electronic display including a liquid crystal display (LCD) panel.

6. The apparatus according to claim 1, the electronic display including a touch-sensitive liquid crystal display (LCD) panel.

7. The apparatus according to claim 1, the electronic display including a scalar board.

8. The apparatus according to claim 1, the electronic display including a first type of signal connector, each of the other entities including a second type of signal connector operably matable to the first type.

9. A system, comprising:
a plurality of electronic displays defined by respectively different sizes, each of the electronic displays configured to receive operating power and electronic signals from another entity;
a plurality of different electronic entities each configured to be operably mated to and positionably supportive of any one of the electronic displays such that a respective integrated device is defined.

10. The system according to claim 9, at least one of the electronic displays and at least one of the electronic entities collectively defining an all-in-one computer.

11. The system according to claim 9, at least one of the electronic displays and at least one of the electronic entities collectively defining a computer monitor.

12. The system according to claim 9, at least one of the electronic displays and at least one of the electronic entities collectively defining television-capable video display.

13. The system according to claim 9, each of the electronic displays including an electronic signal connector of a first type, each of the electronic entities including an electronic signal connector of a second type electrically connectible to the first type.

14. The system according to claim 9, at least one of the electronic displays including at least a touch-sensitive liquid crystal display (LCD) panel.

15. A method, comprising:
electrically coupling an electronic display to one of a plurality of different electronic entities;
providing electrical operating power and electronic signals to the electronic display from the coupled electronic entity; and
positionably supporting the electronic display by way of a corresponding feature of the coupled electronic entity, the electronic display and the coupled electronic entity collectively defining an integrated device.

16. The method according to claim 15 further comprising:
removing the electronic display from the coupled electronic entity;
electrically coupling the electronic display to a different one of the electronic entities, the newly coupled one of the electronic entities providing electrical operating power and electronic signals to the electronic display; and
positionably supporting the electronic display by way of the newly coupled electronic entity such that a different integrated device is defined.
